(19) United States
(12) Patent Application Publication
(10) Pub. No.: US 2026/0329215 A1
(43) Pub. Date: Oct. 22, 2026

(54) IMAGE FORMING APPARATUS, IMAGE FORMING METHOD, AND NON-TRANSITORY RECORDING MEDIUM

(71) Applicants: Masaki YAMANOBE, Kanagawa (JP); Katsuhiko MAEDA, Kanagawa (JP)

(72) Inventors: Masaki YAMANOBE, Kanagawa (JP); Katsuhiko MAEDA, Kanagawa (JP)

(21) Appl. No.: 19/647,896

(22) Filed: Apr. 15, 2026

(30) Foreign Application Priority Data
Apr. 17, 2025 (JP) 2025-068206

(51) Int. Cl. G03G 15/00; G03G 15/01; G06K 15/02

(52) U.S. Cl. CPC G03G 15/5058; G03G 15/011; G03G 15/0121; G03G 15/0126; G03G 15/0131; G03G 15/0189; G06K 15/027; G06K 15/1878; G06K 2215/0094

(57) ABSTRACT

An image forming apparatus includes image bearers, an optical writer, developing devices, a transfer device, and circuitry. The circuitry generates image data of an image misregistration detection pattern, detects toner images of the detection pattern of colors transferred onto a belt, and correct, based on a detection result of the toner images, a deviation of an image position of a color with respect to an image position of a reference color. The detection pattern includes two patterns parallel to and angled to a main scanning direction. The circuitry calculates a reference color correction amount for correcting a deviation of the image position of the reference color in the main scanning direction, based on a detection result of an interval between the two patterns of the reference color, and corrects the deviation of the image position of the reference color in the main scanning direction based on the correction amount.

### CROSS-REFERENCE TO RELATED APPLICATION

This application claims priority to 35 U.S.C. § 119(a) to Japanese Patent Application No. 2025-068206, filed on Apr. 17, 2025, in the Japan Patent Office, the entire disclosure of which is hereby incorporated by reference herein.

### BACKGROUND

### Technical Field

The present disclosure relates to an image forming apparatus, an image forming method, and a non-transitory recording medium.

### Related Art

A color image forming apparatus forms a latent image by irradiating an image bearer with a light beam corresponding to image data, develops the latent image with a developing device, and transfers the developed image onto a recording sheet to form an image. An image misregistration detection pattern of each color is generated on a transfer belt, the image misregistration detection pattern is detected, the amount of deviation of an image position of each color with respect to a reference color is calculated, and the image position is corrected according to the calculation result.

### SUMMARY

The present disclosure provides an image forming apparatus which includes a plurality of image bearers; an optical writer that, according to image data, irradiates the plurality of image bearers with light beams to form latent images; a plurality of developing devices to develop the latent images with toner of a plurality of colors, wherein the plurality of colors includes a reference color and another color other than the reference color; a transfer device to transfer, onto a belt, toner images of the plurality of colors obtained by developing the latent images based on image data of an image misregistration detection pattern, wherein the image misregistration detection pattern includes a first pattern parallel to a main scanning direction in which the light beams from the optical writer move on the plurality of image bearers and a second pattern angled with respect to the main scanning direction; and processing circuitry configured to: generate the image data of the image misregistration detection pattern; detect the toner images of the image misregistration detection pattern of the plurality of colors transferred onto the belt; correct, based on a detection result of the toner images of the image misregistration detection pattern, a deviation of an image position of the another color with respect to an image position of the reference color; calculate, based on a detection result of an interval between the first pattern and the second pattern, a reference color correction amount for correcting a deviation of the image position of the reference color in the main scanning direction; and correct, based on the reference color correction amount, the deviation of the image position of the reference color in the main scanning direction.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 illustrates a printer as an example of an image forming apparatus;

FIG. 2 illustrates an example of an image forming device included in the printer;

FIG. 3 illustrates another example of the image forming device included in the printer;

FIG. 4 illustrates an example of a light beam scanning device included in the printer;

FIG. 5 illustrates an example of an image formation controller and a light beam scanning device of the printer;

FIG. 6 illustrates an example of a front end of an image formation controller of the printer;

FIG. 7 illustrates an example of a printer controller of the printer;

FIG. 8 illustrates an example of a voltage-controlled oscillator (VCO) clock generator of the printer;

FIG. 9 illustrates an example of a writing start position controller of the printer;

FIG. 10 illustrates an example of a timing chart of a writing start position controller in a main scanning direction in the printer;

FIG. 11 illustrates an example of a timing chart of a writing start position controller in a sub-scanning direction in the printer;

FIG. 12 illustrates an example of a flow of control processing at the time of printing of the printer;

FIG. 13 illustrates an example of an image misregistration correction function of the printer;

FIG. 14 illustrates an example of a flow of image misregistration correction in the printer;

FIG. 15 illustrates an example of a process of calculating the amount of deviation of an image position of a reference color in the printer;

FIG. 16 illustrates an example of an image misregistration detection pattern in the printer;

FIG. 17 illustrates an example of an image misregistration detection pattern of the printer;

FIG. 18 illustrates an example of an image misregistration detection pattern of the printer; and

FIG. 19 illustrates an example of setting data of the interval from a horizontal line to an oblique pattern of an image misregistration detection pattern in the printer.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Although the present disclosure is described below with reference to some embodiments, embodiments of the present disclosure are not limited to the embodiments described below. In the drawings referred to below, identical or similar reference numerals are used for the common elements, and the description thereof may be omitted as appropriate.

Hereinafter, embodiments of an image forming apparatus, an image forming method, and a program will be described in detail with reference to the accompanying drawings.

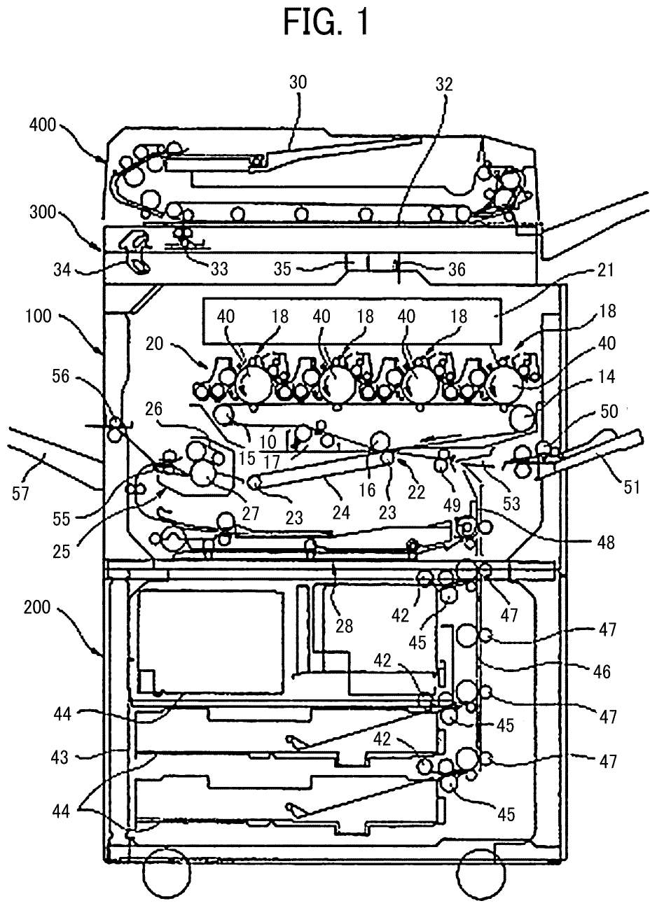

FIG. 1 illustrates a printer as an example of an image forming apparatus. A printer 100, which is an example of an image forming apparatus, includes an intermediate transfer device at the center, and the intermediate transfer device includes an intermediate transfer belt 10, which is an endless belt. The intermediate transfer belt 10 is wound around three support rollers, i.e., a first support roller 14, a second support roller 15, and a third support roller 16 and is rotationally driven in a clockwise direction. On the right side of the second support roller 15, an intermediate transfer member cleaning device 17 removes residual toner remaining on the intermediate transfer belt 10 after the image transfer.

The intermediate transfer belt 10 between the first support roller 14 and the second support roller 15 is disposed with image forming devices 20, which are an example of image formers, each including a photoconductor device 40 of one color of yellow (Y), magenta (M), cyan (C), and black (K), a charger 18, a developing device 11, and a cleaning device 13 disposed along a moving direction of the intermediate transfer belt 10. The image forming devices 20 are detachably attached to a main body of the printer 100.

Above the image forming devices 20, a light beam scanning device 21 irradiates each photoconductor drum 8 of the photoconductor device 40 of each color with laser light for image formation. The light beam scanning device 21 is an example of an optical writer that forms a latent image by irradiating an image bearer such as a photoconductor drum 8 with a laser beam L (an example of a light beam) corresponding to image data. A secondary transfer device 22 is disposed below the intermediate transfer belt 10. The secondary transfer device 22 includes a secondary transfer belt 24, which is an endless belt, stretched between two rollers 23, and is disposed so as to push up the intermediate transfer belt 10 and press the intermediate transfer belt 10 against the third support roller 16. The secondary transfer belt 24 transfers an image on the intermediate transfer belt 10 onto a sheet.

A fixing device 25 that fixes the transferred image on the sheet is disposed on the side of the secondary transfer device 22, and the sheet to which the toner image is transferred is fed thereto. The fixing device 25 heats a fixing belt 26, which is an endless belt, and presses a pressure roller 27 against the fixing belt 26. A sheet reversing device 28 is disposed below the secondary transfer device 22 and the fixing device 25. The sheet reversing device 28 reverses the sheet immediately after an image is formed on the front surface of the sheet and feeds the sheet to record an image on the back surface of the sheet.

When a start switch of an operation panel of the printer 100 is pressed, if there is a document on a document feeding table 30 of an automatic document feeder (ADF) 400, the document is conveyed onto an exposure glass 32. When there is no document on the ADF 400, the scanner of the image reading device 300 is driven to read the document manually placed on the exposure glass 32, and a first carriage 33 and a second carriage 34 are driven to perform reading and scanning. The printer 100 emits light from a light source on the first carriage 33 to the exposure glass 32, reflects light reflected from the document surface by a first mirror on the first carriage 33 toward the second carriage 34, reflects the light by a mirror on the second carriage 34, and forms an image on a charge-coupled device (CCD) 36, which is a reading sensor, through an imaging lens 35. The printer 100 generates print data of each color of Y, M, C, and K based on image signals obtained by the CCD 36.

When a start switch is pressed, or when an image output instruction is received from a personal computer or the like, or when a facsimile (FAX) output instruction is given, the printer 100 starts the rotational driving of the intermediate transfer belt 10, starts image formation preparation of each component of the image forming device 20, starts an image formation sequence of each color image formation, projects an exposure laser modulated based on each color recording data on the photoconductor drum 8 for each color, and transfers each color toner image onto the intermediate transfer belt 10 in an overlapping manner as one image by each color image formation process. A sheet is fed to the secondary transfer device 22 at a timing such that the leading end of the sheet enters the secondary transfer device 22 at the same time as the leading end of the toner image enters the secondary transfer device 22, and thus the toner image on the intermediate transfer belt 10 is transferred to the sheet. The sheet to which the toner image has been transferred is fed to the fixing device 25, where the toner image is fixed to the sheet.

A sheet is fed from one of sheet feeding trays 44 at multiple stages in a sheet feeding device 43 by selectively rotating one of sheet feeding rollers 42 of a sheet feeding table 200, separated by separation rollers 45, conveyed to a conveyance roller 48 by conveyance rollers 47 through a sheet conveyance path 46, stopped by registration rollers 49 of the conveyance roller 48, and then sent to the secondary transfer device 22 at the above-described timing. The printer 100 can also feed a sheet by inserting the sheet on a bypass feed tray 51. When the user inserts the sheet on the bypass feed tray 51, the printer 100 rotationally drives a sheet feeding roller 50 to separate one of the sheets on the bypass feed tray 51 and draw the sheet into a bypass sheet feeding path 53. Similarly, the sheet is stopped by abutting against the registration rollers 49.

The sheet subjected to the fixing process by the fixing device 25 and ejected is guided to an ejection roller 56 by a switching claw 55 and stacked on a sheet ejection tray 57. Alternatively, the sheet to be ejected after the fixing process is guided to the sheet reversing device 28 by the switching claw 55, reversed there, guided to the transfer position again, and ejected onto the sheet ejection tray 57 by the ejection roller 56 after an image is recorded on the back surface. On the other hand, residual toner remaining on the intermediate transfer belt 10 after image transfer is removed by the intermediate transfer member cleaning device 17, and the intermediate transfer belt 10 is prepared for the next image formation.

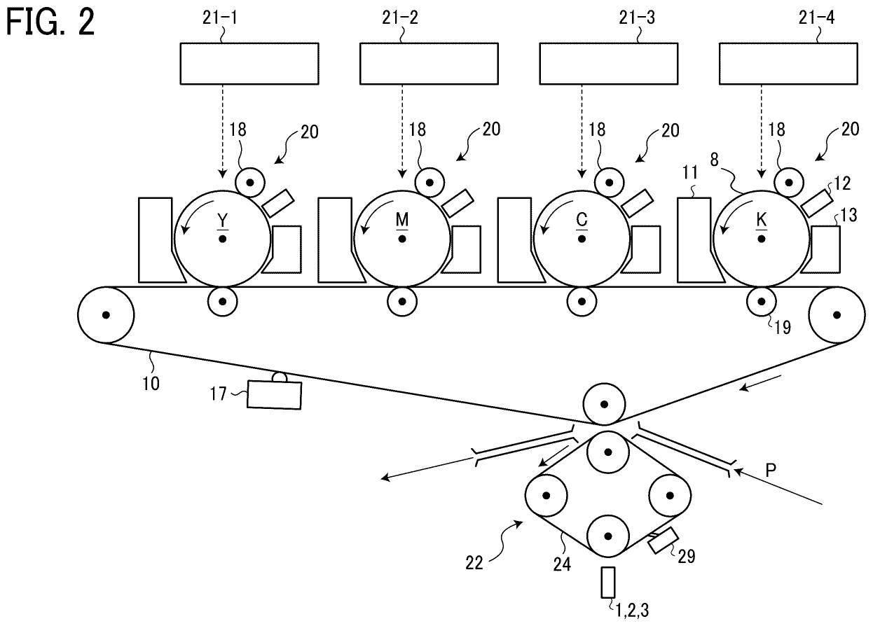

FIG. 2 illustrates an example of an image forming device included in the printer. In the present embodiment, the printer includes four sets of image forming devices 20 and four sets of light beam scanning devices 21-1, 21-2, 21-3, and 21-4, which may be referred to as light beam scanning device(s) 21 unless distinguished, in order to form a color image in which images of four colors (yellow, magenta, cyan, and black) are superimposed.

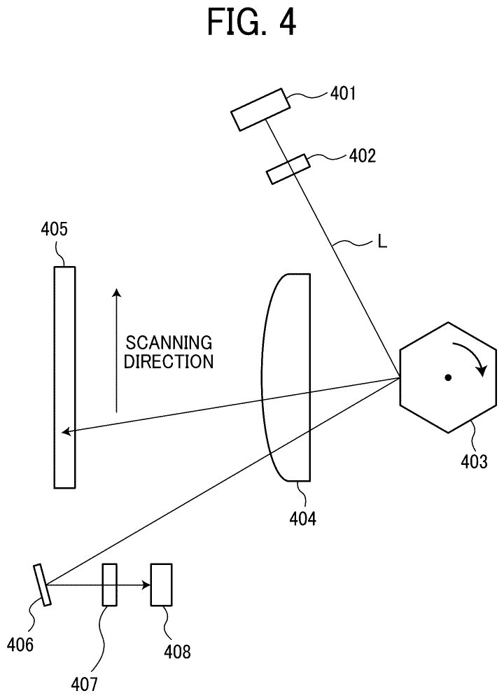

As will be described later with reference to FIG. 4, the light beam scanning device 21 includes a laser diode (LD) that selectively emits a light beam L by being driven and modulated according to image data, and the emitted light beam is deflected by a polygon mirror rotated by a polygon motor, passes through an fθ lens, is reflected by a return mirror, and scans a photoconductor drum 8.

Each of the image forming devices 20 for the respective colors includes a charger 18, a developing device 11, a transfer roller 19, a cleaning device 13, and a static eliminator 12 around the photoconductor drum 8. The image forming device 20 forms an image of a first color on the intermediate transfer belt 10 by charging, exposure, development, and transfer, which are normal electrophotographic processes, and then transfers images of a second color, a third color, and a fourth color in this order to form a color image in which images of four colors are superimposed, and further transfers the image formed on the intermediate transfer belt 10 to a recording sheet (paper) conveyed by the secondary transfer device 22, thereby forming a color image in which images of four colors are superimposed on the recording sheet. That is, the developing device 11 of the image forming device 20 of each color is an example of a toner developing device of a plurality of colors that visualizes a latent image formed on an image bearer such as the photoconductor drum 8. Then, the image on the recording sheet is fixed by the fixing device 25. The intermediate transfer member cleaning device 17 removes the toner image on the intermediate transfer belt 10.

The secondary transfer device 22 includes a sensor 1, a sensor 2, and a sensor 3 for detecting an image misregistration detection pattern formed on the secondary transfer belt 24. The sensors 1 to 3 are an example of a plurality of sensors arranged along a main scanning direction. The sensors 1, 2, and 3 are reflective optical sensors. The sensors 1 to 3 detect the image misregistration detection patterns transferred from the intermediate transfer belt 10 onto the secondary transfer belt 24, and based on the detection results of the transferred image misregistration detection patterns, image misregistration in the main scanning direction and a sub-scanning direction between the respective colors and the image magnification in the main scanning direction are corrected. A secondary transfer belt cleaning device 29 removes the toner image on the secondary transfer belt 24. The image forming device 20 includes a toner bottle containing toner to be supplied to the developing device 11 for each color.

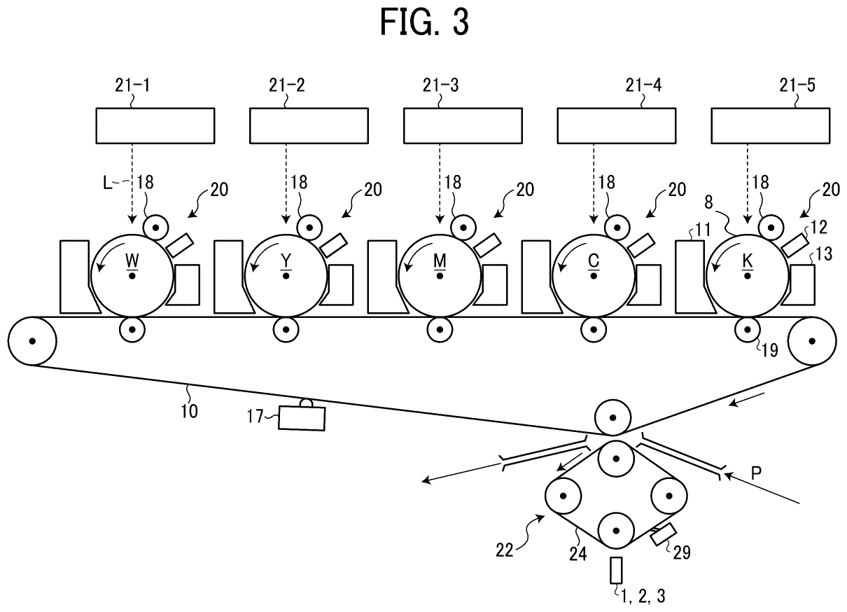

FIG. 3 illustrates another example of the image forming device included in the printer. In the present embodiment, the printer 100 may include five sets of image forming devices 20 and five sets of light beam scanning devices 21-1, 21-2, 21-3, 21-4, and 21-5, which may be referred to as light beam scanning device(s) 21 unless distinguished. The five sets of image forming devices 20 include one image forming device 20 for a spot color in addition to the image forming devices 20 for four colors in order to form a color image in which images of the four colors and the spot color are superimposed. In the present embodiment, the spot color is white (W color). The basic operation of the image forming device 20 shown in FIG. 3 is the same as that of the image forming device 20 shown in FIG. 2.

FIG. 4 illustrates an example of a light beam scanning device included in the printer. FIG. 4 is a top view of the light beam scanning device 21 shown in FIGS. 2 and 3. The light beam scanning devices 21-1 to 21-5 of the respective colors have the same configuration. In the following description, when the light beam scanning devices 21-1 to 21-5 are not distinguished from each other, the light beam scanning devices 21-1 to 21-5 are also referred to as light beam scanning devices 21.

In the present embodiment, in the light beam scanning device 21, a light beam L emitted from an LD 401 passes through a cylinder lens (CYL) 402, enters a polygon mirror 403, is deflected by rotation of the polygon mirror 403, passes through an fθ lens 404, and scans a photoconductor drum 8 by a return mirror 405.

A synchronous mirror 406, a synchronous lens 407, and a synchronization detection sensor 408 are disposed at an end portion on a writing side in the main scanning direction, and the light beam transmitted through the fθ lens 404 is reflected by the synchronous mirror 406, is condensed by the synchronous lens 407, and is incident on the synchronization detection sensor 408. The synchronization detection sensor 408 serves to detect a synchronization detection signal that determines the writing start timing of the main scanning.

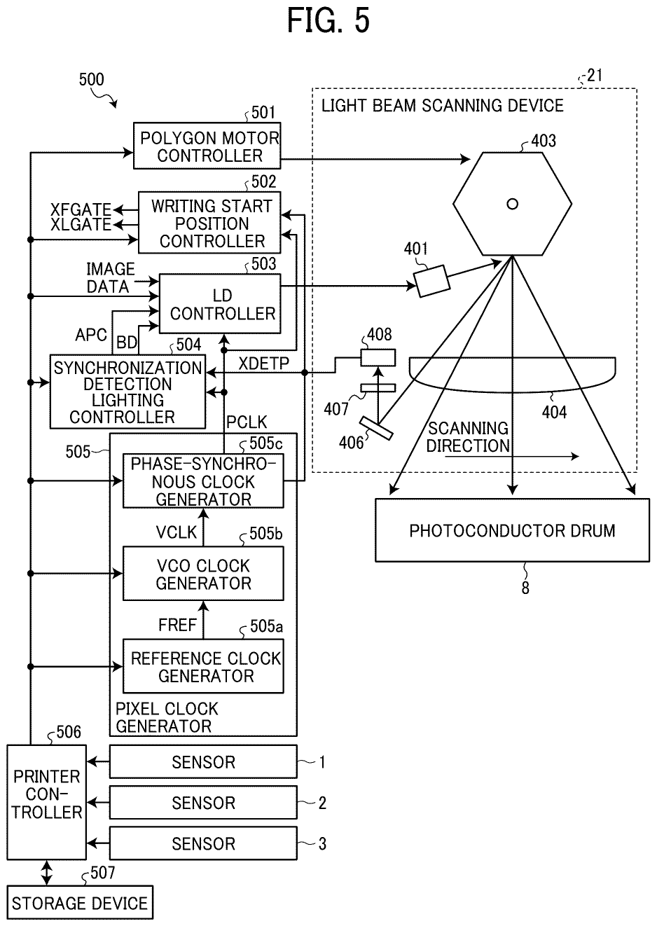

FIG. 5 illustrates an example of an image formation controller and a light beam scanning device of the printer. Although FIG. 5 shows the image formation controller 500 and the light beam scanning device 21 for one color, the components other than a printer controller 506, a storage device 507, the sensor 1, the sensor 2, and the sensor 3 are provided for each color.

In exemplary embodiments, the image formation controller 500 and its sub-components may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, devices, or means are hardware that carry out or are programmed to perform the recited functionality. The hardware may be any hardware disclosed herein which is programmed or configured to carry out the recited functionality.

In exemplary embodiments, the storage 507 is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

The light beam scanning device 21 includes a synchronization detection sensor 408 that detects a light beam on an image writing start side of an end portion of the light beam scanning device 21 in the main scanning direction, and is configured such that the light beam transmitted through the fθ lens 404 is reflected by a synchronization mirror 406, is condensed by a synchronization lens 407, and is incident on the synchronization detection sensor 408. In the light beam scanning device 21, when the light beam passes over the synchronization detection sensor 408, a synchronization detection signal XDETP is output from the synchronization detection sensor 408 and is sent to a pixel clock generator 505, a synchronization detection lighting controller 504, and a writing start position controller 502.

The pixel clock generator 505 is a circuit that generates a pixel clock PCLK synchronized with the synchronization detection signal XDETP by a reference clock generator 505a, a voltage-controlled oscillator (VCO) clock generator 505b, and a phase-synchronous clock generator 505c, and sends the pixel clock PCLK to the writing start position controller 502 and the synchronization detection lighting controller 504. The synchronization detection lighting controller 504 turns on an LD forced lighting signal BD to forcibly light the LD 401 in order to first detect the synchronization detection signal XDETP. After detecting the synchronization detection signal XDETP, the synchronization detection lighting controller 504 generates an LD forced lighting signal BD for turning on the LD 401 at a timing at which the synchronization detection signal XDETP can be reliably detected without generating flare light using the synchronization detection signal XDETP and the pixel clock PCLK, and turning off the LD 401 when the synchronization detection signal XDETP is detected, and sends the LD forced lighting signal BD to the LD controller 503.

The synchronization detection lighting controller 504 is a circuit that generates a light amount control timing signal APC of each LD 401 using the synchronization detection signal XDETP and the pixel clock PCLK, and sends the light amount control timing signal APC to the LD controller 503. The light amount control timing signal APC is executed outside the image writing region, and the light amount is controlled to a target light amount at that timing.

The LD controller 503 is a circuit that controls the lighting of the LD 401 in accordance with the LD forced lighting signal BD, the light amount control timing signal APC, and the pixel clock PCLK. Accordingly, the LD controller 503 emits a laser beam from the LD 401, deflects the laser beam by the polygon mirror 403, passes the laser beam through the fθ lens 404, and scans the laser beam on the photoconductor drum 8 by the return mirror 405.

The polygon motor controller 501 is a circuit that controls the rotation of the polygon motor at a predetermined rotation speed in accordance with a control signal from the printer controller 506.

The writing start position controller 502 is a circuit that generates a main scanning control signal XLGATE and a sub-scanning control signal XFGATE for determining an image writing start timing and an image width, based on the synchronization detection signal XDETP, the pixel clock PCLK, a control signal from the printer controller 506, and the like.

The sensors 1, 2, and 3 for detecting the image misregistration detection patterns send image pattern information detected by the respective sensors to the printer controller 506. The printer controller 506 calculates the amount of deviation of the image position, generates correction data, sets the correction data in the writing start position controller 502 and the pixel clock generator 505, and stores the correction data in the storage device 507.

When an image forming operation is performed, the correction data stored in the storage device 507 is read out in accordance with an instruction from the printer controller 506, and the correction data is set in the writing start position controller 502 and the pixel clock generator 505.

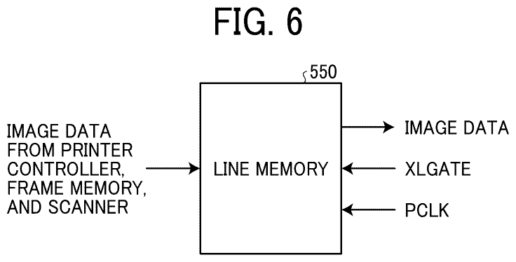

FIG. 6 illustrates an example of a front end of an image formation controller of the printer. A line memory 550 is provided in a front end of the image formation controller 500, and image signals corresponding to the number of beams are output in synchronization with a pixel clock PCLK from image data taken in from a printer controller, a frame memory, a scanner, or the like at the timing of a sub-scanning control signal XFGATE and a main scanning control signal XLGATE. The image signal output from the line memory 550 is sent to the LD controller 503, and each LD 401 is turned on at that timing.

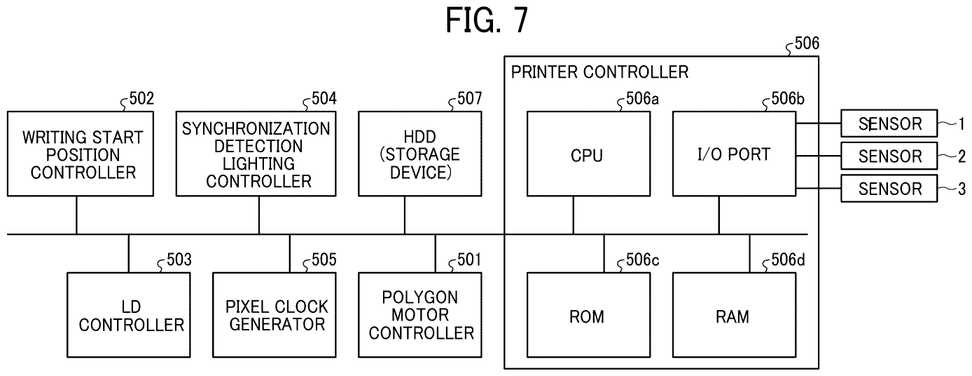

FIG. 7 illustrates an example of a printer control device of the printer. In the present embodiment, the printer controller 506 includes a central processing unit (CPU) 506a, a random-access memory (RAM) 506d, a read-only memory (ROM) 506c, and an input/output (I/O) port 506b, and the respective hardware components are connected via a bus.

The CPU 506a is circuitry that executes a program for controlling the operation of the printer 100 and performs predetermined processing. The RAM 506d is a volatile storage device for providing an execution space for a program executed by the CPU 506a. The ROM 506c is a nonvolatile storage device for storing programs, firmware, and the like executed by the CPU 506a. The I/O port 506b processes information output to a motor controlled by the CPU 506a, information input from various sensors, and the like.

Sensors 1, 2, and 3 for detecting an image pattern are connected to the I/O port 506b. The printer controller 506 is also connected to a writing start position controller 502, an LD controller 503, a synchronization detection lighting controller 504, a pixel clock generator 505, a storage device 507 such as a hard disk drive (HDD), and a polygon motor controller 501 via the bus, and performs various settings, ON/OFF control, and storage and reading of information according to instructions from the CPU 506a.

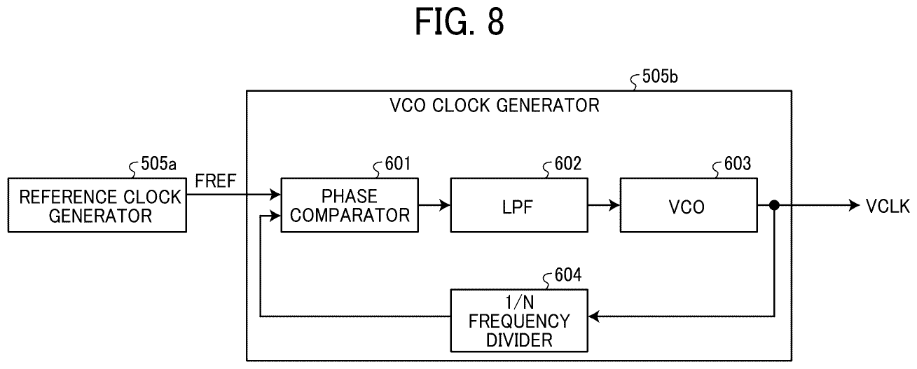

FIG. 8 illustrates an example of a voltage-controlled oscillator (VCO) clock generation device of the printer. In the present embodiment, the VCO clock generator 505b inputs a reference clock signal FREF from the reference clock generator 505a and signals obtained by dividing a voltage clock (VCLK) by N using a 1/N frequency divider 604 to a phase comparator 601. The phase comparator 601 compares the phases of the falling edges of the two signals and outputs an error component as a constant current. A low pass filter (LPF) 602 removes unnecessary high-frequency components and noise from error components output from the phase comparator 601, and sends the result to the VCO 603. The VCO 603 outputs an oscillation frequency depending on the output of the LPF 602. Therefore, the VCO clock generator 505b can vary the frequency of the VCLK by varying the frequency of the reference clock signal FREF from the printer controller 506 and the frequency dividing ratio N. As the frequency of VCLK changes, the frequency of the pixel clock PCLK also changes.

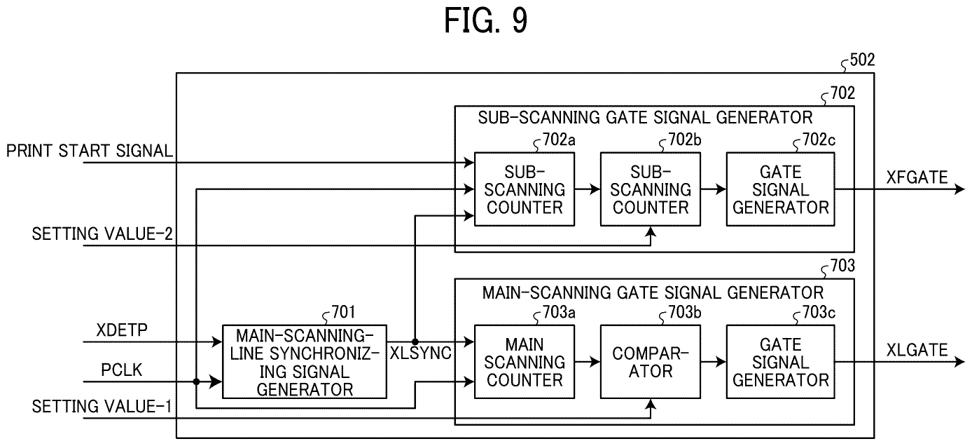

FIG. 9 illustrates an example of a writing start position control device of the printer. In the present embodiment, the writing start position controller 502 includes a main-scanning-line synchronizing signal generator 701, a main-scanning gate signal generator 703, and a sub-scanning gate signal generator 702. The main-scanning-line synchronizing signal generator 701 generates a signal XLSYNC for operating a main scanning counter 703a in the main-scanning gate signal generator 703 and a sub-scanning counter 702a in the sub-scanning gate signal generator 702.

The main-scanning gate signal generator 703 generates a main scanning control signal XLGATE that determines the timing of capturing an image signal (the timing of writing an image in the main scanning direction). The sub-scanning gate signal generator 702 generates a sub-scanning control signal XFGATE that determines the timing of capturing an image signal (the timing of writing an image in the sub-scanning direction).

The main-scanning gate signal generator 703 includes a main scanning counter 703a that operates with the signal XLSYNC and the pixel clock PCLK, a comparator 703b that compares a counter value of the main scanning counter 703a with a set value 1 (correction data) from the printer controller 506 and outputs the comparison result, and a gate signal generator 703c that generates a main scanning control signal XLGATE from the comparison result output from the comparator 703b.

The sub-scanning gate signal generator 702 includes a sub-scanning counter 702a that operates in response to a print start signal, the signal XLSYNC, and the pixel clock PCLK from the printer controller 506, a comparator 702b that compares a counter value of the sub-scanning counter 702a with a setting value 2 from the printer controller 506 and outputs the comparison result, and a gate signal generator 702c that generates the sub-scanning control signal XFGATE from the comparison result output from the comparator 702b.

The writing start position controller 502 can correct the writing start position in devices of one cycle of the pixel clock PCLK, that is, in devices of one dot in the main scanning direction, and in devices of one cycle of the signal XLSYNC, that is, in devices of one line in the sub-scanning direction. The correction data in both the main scanning direction and the sub-scanning direction is stored in the storage device 507.

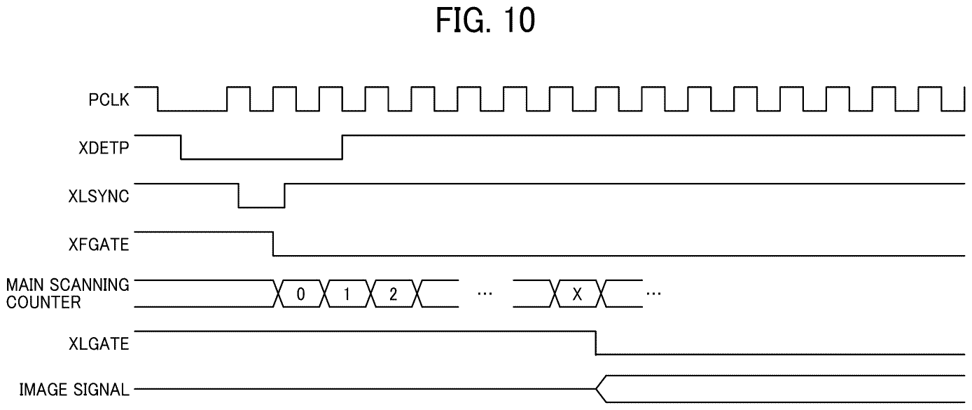

FIG. 10 illustrates an example of a timing chart of a writing start position control device in a main scanning direction in the printer. In the present embodiment, in the writing start position controller 502, the main scanning counter 703a is reset by the signal XLSYNC, the counter value is counted up by the pixel clock PCLK, and when the counter value reaches a set value 1 (in this case, X) set by the printer controller 506, the comparison result is output from the comparator 703b, and the main scanning control signal XLGATE is set to a low level (valid) by the gate signal generator 703c. The main scanning control signal XLGATE is a signal that is at the low level for an image width in the main scanning direction.

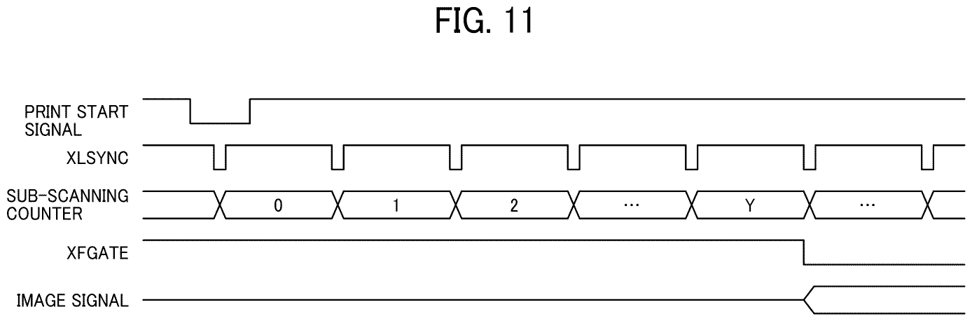

FIG. 11 illustrates an example of a timing chart of a writing start position control device in a sub-scanning direction in the printer. In the present embodiment, in the writing start position controller 502, the sub-scanning counter 702a is reset by the print start signal from the printer controller 506, the sub-scanning counter 702a is counted up by the signal XLSYNC, and when the counter value reaches the set value 2 (in this case, Y) set by the printer controller 506, the comparison result is output from the comparator 702b, and the sub-scanning control signal XFGATE is set to the low level (valid) by the gate signal generator 702c. The sub-scanning control signal XFGATE is a signal that is at the low level for an image length in the sub-scanning direction.

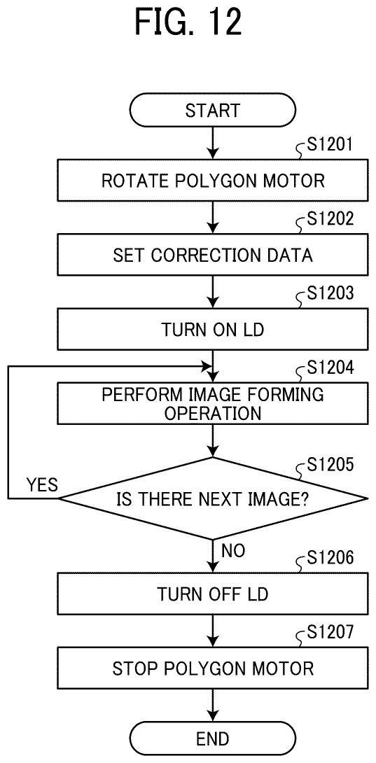

FIG. 12 illustrates an example of a flow of control processing at the time of printing of the printer. In the present embodiment, when a start key of the operation panel is pressed, first, the polygon motor controller 501 rotates the polygon motor at a specified rotation speed according to an instruction from the printer controller 506 (step S1201).

Then, the printer controller 506 sets correction data (for example, writing start positions in the main scanning direction and the sub-scanning direction, and setting values of magnification) in each controller (step S1202), turns on the LD 401 (step S1203) in order to output the synchronization detection signal XDETP, and performs an APC operation for setting a state in which each LD 401 can be turned on with a specified light amount.

Thereafter, the printer controller 506 starts an image forming operation (step S1204), and if there is no next image (step S1205: No), turns off each LD 401 (step S1206), stops the polygon motor (step S1207), and ends the process.

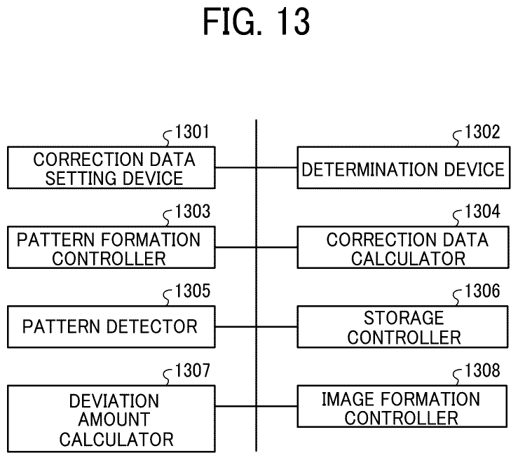

FIG. 13 illustrates an example of an image misregistration correction function of the printer. To be more specific, FIG. 13 is a functional block diagram of functions realized by the CPU 506a executing an image misregistration correction program stored in the ROM 506c. As illustrated in FIG. 13, the printer controller 506 executes the image misregistration correction program by the CPU 506a to implement the functions of a correction data setting device 1301, a pattern formation controller 1303, a pattern detector 1305, a deviation amount calculator 1307, a determination device 1302, a correction data calculator 1304, a storage controller 1306, and an image formation controller 1308.

The correction data setting device 1301 sets the correction data stored in the storage device 507 in the writing start position controller 502 and the pixel clock generator 505.

The pattern formation controller 1303 is an example of a generator that generates image data of an image misregistration detection pattern. The image misregistration detection pattern may be two patterns including a pattern parallel to the main scanning direction which is the irradiation direction of the laser light and a pattern inclined with respect to the main scanning direction.

The pattern formation controller 1303 forms an image misregistration detection pattern on the secondary transfer belt 24 (an example of a belt) based on the generated image data. Specifically, the pattern formation controller 1303 causes the secondary transfer device 22 (an example of a transfer device) to transfer, onto the secondary transfer belt 24, a toner image of a plurality of colors obtained by visualizing a latent image based on the image data of the image misregistration detection pattern.

The pattern detector 1305 detects the image misregistration detection pattern formed on the secondary transfer belt 24 based on the sensor outputs of the sensor 1, the sensor 2, and the sensor 3. That is, the pattern detector 1305 is an example of a detector that detects the toner images of the image misregistration detection patterns of a plurality of colors transferred onto the secondary transfer belt 24 using the sensors 1 to 3.

The deviation amount calculator 1307 calculates the amount of deviation of the image position of the reference color and the amount of deviation of the image position of each color with respect to the reference color based on the image misregistration detection pattern detected by the pattern detector 1305.

The determination device 1302 determines whether to perform the image misregistration correction based on the calculated amount of deviation of the image position of the reference color and the amount of deviation of the image position of each color with respect to the reference color.

The correction data calculator 1304 calculates correction data when performing image registration correction. The correction data calculator 1304 calculates correction data (an example of a reference color correction amount) for correcting the deviation of the image position of the reference color in the main scanning direction based on the detection result of the interval between two pattern lines of the reference color in the image misregistration detection pattern.

The correction data calculator 1304 may correct the deviation of the image position of the reference color using the correction data (reference color correction amount) calculated in the previous correction of the deviation of the image position. This can suppress the temporal change in the image position of the reference color. Alternatively, the correction data calculator 1304 may calculate correction data (reference color correction amount) for correcting the deviation of the image position of the reference color using the pattern setting data used in the generation of the image misregistration detection pattern. This makes it possible to suppress a temporal change in the image position of the reference color.

The correction data calculator 1304 may calculate correction data (reference color correction amount) for correcting the deviation of the image position of the reference color based on the detection result using a sensor (for example, the sensor 1) on the scanning start side among the plurality of sensors 1 to 3. This simplifies the control of the correction of the image misregistration. Alternatively, the correction data calculator 1304 may calculate correction data (reference color correction amount) for correcting the deviation of the image position of the reference color based on the detection results using the plurality of sensors 1 to 3. This makes it possible to enhance the accuracy of correction of the image misregistration.

The storage controller 1306 updates the correction data stored in the storage device 507 with the calculated correction data.

The image formation controller 1308 performs print processing based on the calculated correction data. Specifically, the image formation controller 1308 corrects the deviations of the image positions of the other colors with respect to the reference color serving as a reference among the plurality of colors based on the detection result of the toner image of the image misregistration detection pattern. In the present embodiment, the correction data calculator 1304 and the image formation controller 1308 function as an example of processing circuitry that corrects image misregistration.

The image formation controller 1308 corrects the positional deviation of the reference color in the main scanning direction based on the correction data (reference color correction amount) calculated by the correction data calculator 1304. Accordingly, the image misregistration correction of the reference color is executed at the same timing as the image misregistration correction performed on the colors other than the reference color, and thus the temporal change in the image position can be suppressed.

The image formation controller 1308 may correct the deviations of the image positions of the other colors in the main scanning direction based on the correction data (reference color correction amount). Thus, the temporal change of the image position and the misregistration between the respective colors are simultaneously corrected.

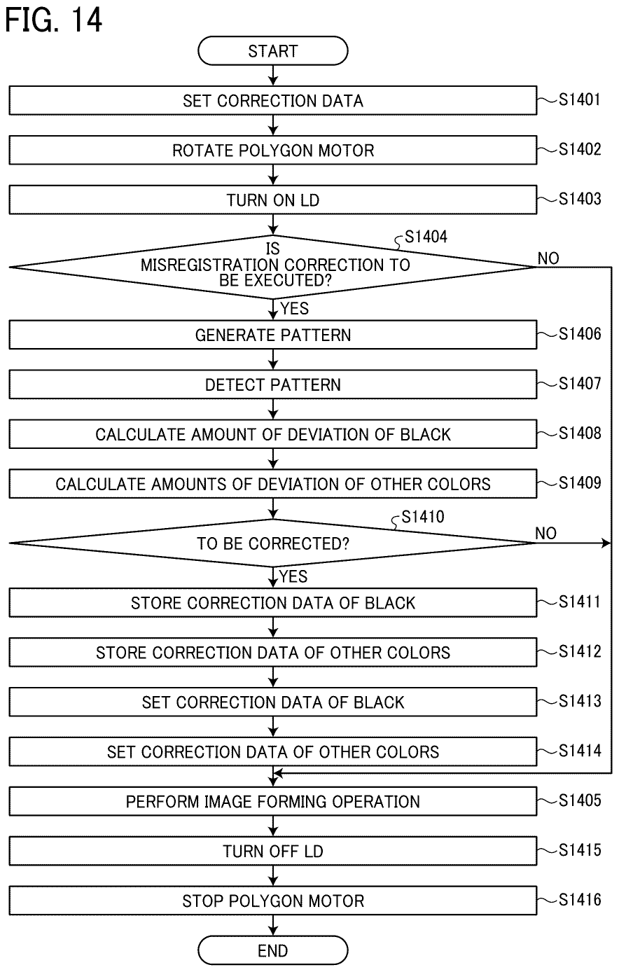

FIG. 14 illustrates an example of a flow of image misregistration correction in the printer. The printer controller 506 controls the execution timing of the image misregistration correction. The printer controller 506 executes the image misregistration correction when the print mode is switched, each time a specified number of sheets are printed, or when the temperature is monitored and a change equal to or larger than a specified value occurs.

First, the correction data setting device 1301 sets the correction data stored in the storage device 507 (step S1401). The correction data to be set is correction data set in the previous correction operation and is stored in the storage device 507. Next, the determination device 1302 controls the polygon motor controller 501 to rotate the polygon motor (step S1402), turns on the LD 401 (step S1403), and confirms whether to execute the image misregistration correction (step S1404). Specifically, since the image misregistration occurs due to a temperature change and a lapse of time (for example, the number of printed sheets from the previous time), the determination device 1302 confirms whether or not a predetermined execution condition is satisfied for the image misregistration correction, and determines whether or not to execute the image misregistration correction.

When the image misregistration correction is not executed (step S1404: No), the image formation controller 1308 starts the image forming operation as it is (step S1405). When the image misregistration correction is to be executed (step S1404: Yes), the pattern formation controller 1303 generates an image misregistration detection pattern (step S1406). The pattern detector 1305 detects the image misregistration detection pattern by the sensor 1, the sensor 2, and the sensor 3 (step S1407). The deviation amount calculator 1307 calculates the amounts of deviations of the other colors with respect to the reference color (for example, K color) and the amount of deviation of the reference color itself (step S1408 and step S1409).

Then, the determination device 1302 determines whether to perform the image misregistration correction (step S1410). In this determination, it is determined that the correction is performed if the amount of deviation is equal to or greater than ½ of the correction resolution. When the image misregistration correction is performed (step S1410: Yes), the correction data calculator 1304 calculates the correction data of the reference color and the other colors, updates the correction data in the storage device 507 (step S1411 and step S1412), and sets the correction data in each controller (step S1413 and step S1414).

Since the correction data of the colors other than the reference color is relative correction data, it is appropriate to add the correction data of the reference color at the time of setting. The correction data here includes a set value of a pixel clock frequency that determines an image magnification in the main scanning direction, a set value of a main scanning control signal XLGATE that determines an image position in the main scanning direction, and a set value of a sub-scanning control signal XFGATE that determines an image position in the sub-scanning direction. The correction data of the reference color is a set value of the main scanning control signal XLGATE that determines the image position in the main scanning direction. If the correction is not performed (step S1410: No), the correction data is not updated.

After the image misregistration correction is performed, the image formation controller 1308 starts an image forming operation (step S1405). If there is no next image, the image formation controller 1308 turns off the LD 401 (step S1415) and stops the polygon motor (step S1416).

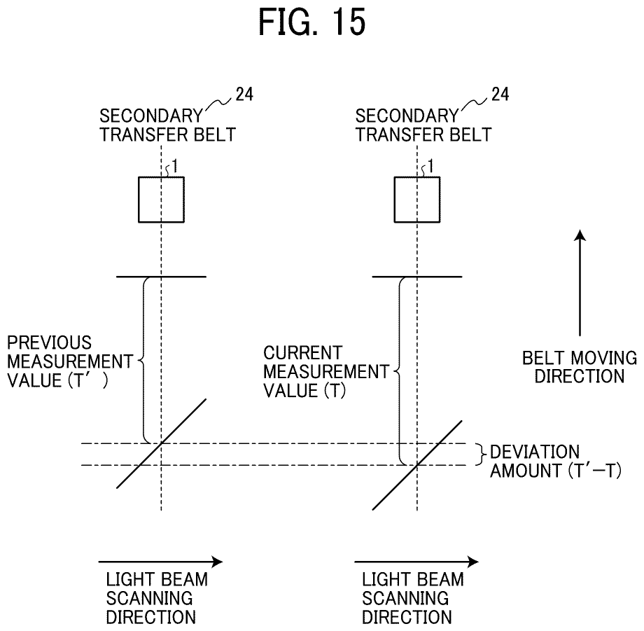

FIG. 15 illustrates an example of a process of calculating the amount of deviation of an image position of a reference color in the printer. In the present embodiment, the pattern formation controller 1303 forms a toner image of an image misregistration detection pattern including horizontal lines and oblique lines of the respective colors on the secondary transfer belt 24. As the secondary transfer belt 24 moves in the belt moving direction (sub-scanning direction) indicated by the arrow in FIG. 15, the horizontal line and the oblique line are detected by the sensor 1 and sent to the pattern detector 1305.

The deviation amount calculator 1307 measures a measurement time T from a horizontal line to an oblique line of the reference color for each correction, and calculates a temporal deviation of the image position of the reference color from a difference between the measurement time T and a measurement time T′ from the horizontal line to the oblique line in the previous correction. The detection timing of the oblique line changes due to the deviations of the image position and the image magnification in the main scanning direction, and the detection timing of the horizontal line changes due to the deviation of the image position in the sub-scanning direction. In particular, when the oblique line is inclined at 45° with respect to the horizontal line, the same amount of deviation in the main scanning direction appears in the sub-scanning direction. In the present embodiment, the angle of each oblique line included in the image misregistration detection pattern is 45 degrees, but the angle is not limited thereto, and the amount of deviation can be calculated by calculation as long as the angle is a preset angle.

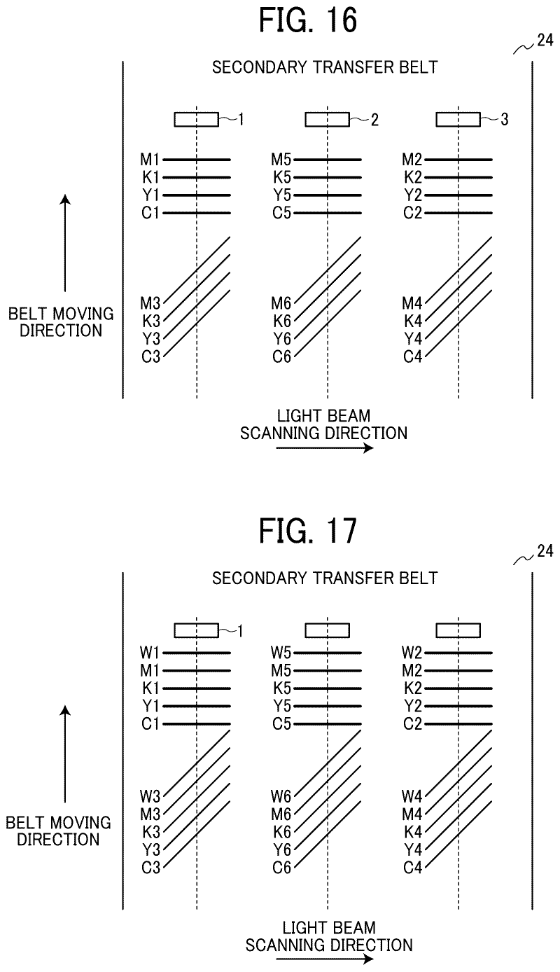

Specifically, when the amount of deviation (measurement time T-measurement time T′) is a positive number, it indicates that the image forming position of the pattern of the reference color is deviated in the right direction from the previous time (the writing start timing is delayed), and when the amount of deviation is a negative number, it indicates that the image forming position of the pattern of the reference color is deviated in the left direction (the writing start timing is advanced). In FIG. 15, the sensor 1 is shown as a sensor for detecting the image misregistration detection pattern, but the same applies to the cases of the sensor 2 and the sensor 3. The correction of the image positions of the other colors including the reference color and a specific correction method of the image position of the reference color will be described later with reference to FIG. 16 and subsequent drawings.

FIG. 16 illustrates an example of an image misregistration detection pattern in the printer. In the present embodiment, the pattern formation controller 1303 forms a toner image of an image misregistration detection pattern including horizontal lines (M1, K1, Y1, C1, M5, K5, Y5, C5, and M2, K2, Y2, C2) and oblique lines (M3, K3, Y3, C3, M6, K6, Y6, C6, and M4, K4, Y4, C4) of the respective colors on the secondary transfer belt 24. As the secondary transfer belt 24 moves in the belt moving direction indicated by the arrow in FIG. 16, a horizontal line and an oblique line of the respective colors are detected by each of the sensor 1, the sensor 2, and the sensor 3, and are sent to the deviation amount calculator 1307, and the amount of deviation (time) of each of the other colors (for example, M color, C color, and Y color) with respect to the reference color (for example, K color) is calculated.

Specifically, the deviation amount calculator 1307 compares the time from the detection of a pattern line K1 to the detection of a pattern line K3 with the time from the detection of a pattern line C1 to the detection of a pattern line C3 as a reference, and obtains the deviation amount TKC13 in the main scanning direction. Further, the deviation amount calculator 1307 compares the time from the detection of a pattern line K2 to the detection of a pattern line K4 with the time from the detection of a pattern line C2 to the detection of a pattern line C4 as a reference, and obtains the deviation amount TKC24. Since TKC24−TKC13 (TKC24 minus TKC13) is a magnification error of the cyan image with respect to the black image, the frequency of the pixel clock is varied by an amount corresponding to the amount of the magnification error.

The amount obtained by subtracting the amount of correction of the magnification error at the position of the sensor 1 from the deviation amount TKC13 obtained as described above is the amount of deviation of the image position of the C color toner image (cyan image) from the K color toner image (black image) in the main scanning direction. The image formation controller 1308 changes the timing of the main scanning control signal XLGATE for determining the writing start timing by an amount corresponding to the amount of deviation. The same applies to magenta and yellow.

In the sub-scanning direction, when an ideal time (time calculated from a value set for generating the image misregistration detection pattern) is Tc, a time from detection of the pattern line K1 to detection of the pattern line C1 is TKC1, a time from detection of the pattern line K2 to detection of the pattern line C2 is TKC2, and a time from detection of the pattern line to detection of the pattern line is, ((TKC2+TKC1+TKC5)/3)−Tc is an amount of deviation of the cyan image with respect to the black image in the sub-scanning direction. The image formation controller 1308 changes the timing of the sub-scanning control signal XFGATE for determining the writing start timing by an amount corresponding to the amount. The same applies to magenta and yellow.

As for the image position of the reference color, the image formation controller 1308 corrects the deviation (writing timing) of the image position in the main scanning direction by using pattern lines of the reference color (for example, K color) in the image misregistration detection pattern formed on the secondary transfer belt 24. The correction includes the following first to third methods.

The first method is a method in which only the sensor 1 on the scanning start side is used and control is simplified. The time obtained by subtracting a time TK′13 from the detection of the pattern line K1 to the detection of the pattern line K3 in the execution of the previous correction, from a time TK13 from the detection of the pattern line K1 to the detection of the pattern line K3 in the current correction, is set as the amount of deviation of the reference color (for example, K color), and the deviation of the image position in the main scanning direction is corrected. That is, the correction data calculator 1304 calculates correction data for correcting the deviation of the image position of the reference color based on the detection result using the sensor 1 on the scanning start side among the plurality of sensors 1 to 3. Then, the image formation controller 1308 corrects the deviation of the image position of the reference color in the main scanning direction based on the correction data.

The second method is a method that uses the sensor 1 and the sensor 2 and takes into account a magnification error. The magnification error in the main scanning direction is obtained from TK24−TK13 (TKC24 minus TKC13), and the amount of deviation of the image position expected after the magnification error correction is added to TK13 to obtain a new amount TK13c. The time obtained by subtracting a deviation amount TK′13c in the previous execution, which is obtained in the same manner as above, from the amount TK13c is used as the amount of deviation of the reference color (for example, K color) to correct the deviation of the image position in the main scanning direction.

The third method is a method using the three sensors 1 to 3. The deviation of the image position in the main scanning direction is corrected by using a time obtained by subtracting the average time TK′_avg of the times TK′13, TK′24, and TK′56 in the execution of the previous correction from the average TK_avg of the times TK13, TK24, and TK56 between respective pattern lines as the amount of deviation of the reference color (for example, K color). The shape of the image misregistration detection pattern is an example, and is not limited thereto. That is, the correction data calculator 1304 calculates correction data for correcting the deviation of the image position of the reference color based on the detection results using the plurality of sensors 1 to 3. Then, the image formation controller 1308 corrects the deviation of the image position of the reference color in the main scanning direction based on the correction data.

FIG. 17 illustrates an example of an image misregistration detection pattern of the printer. In the image forming devices 20 of five colors to which the spot color is added illustrated in FIG. 3, the image misregistration detection pattern is formed as an image misregistration detection pattern, to which the spot color is added as illustrated in FIG. 17, on the secondary transfer belt 24 and includes horizontal lines (W1, M1, K1, Y1, C1, W5, M5, K5, Y5, C5, and W2, M2, K2, Y2, C2) and oblique lines (W3, M3, K3, Y3, C3, W6, M6, K6, Y6, C6, and W4, M4, K4, Y4, C4) of the respective colors. The correction of the deviation of the image position of the spot color is performed in the same manner as described with reference to FIG. 16.

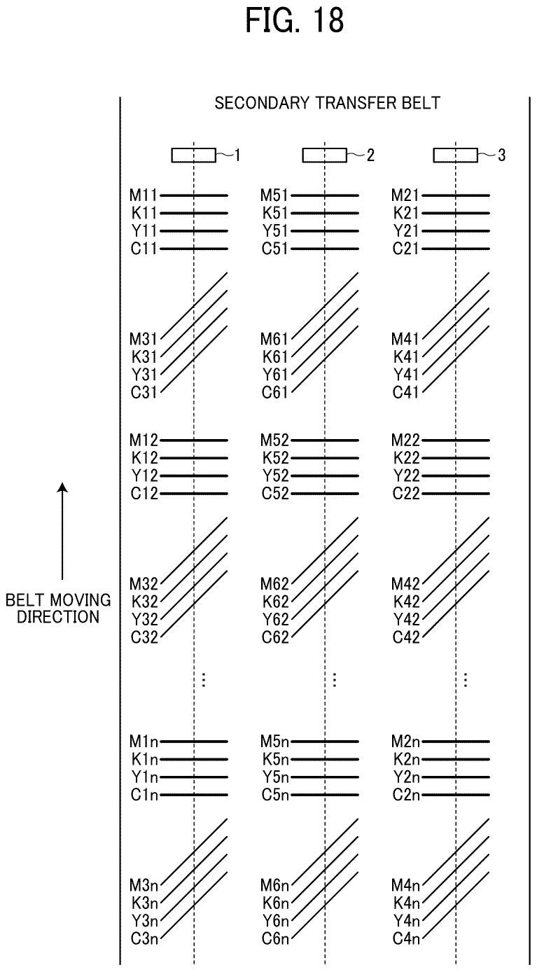

FIG. 18 illustrates an example of an image misregistration detection pattern of the printer. In the present embodiment, a plurality of image misregistration detection patterns, each of which is an image misregistration detection pattern as illustrated in FIG. 16, are arranged in the moving direction of the secondary transfer belt 24. For example, an image misregistration detection pattern including horizontal lines (M11, K11, Y11, C11, M51, K51, Y51, C51, and M21, K21, Y21, C21) and oblique lines (M31, K31, Y31, C31, M61, K61, Y61, C61, and M41, K41, Y41, C41) of the respective colors is followed by another image misregistration detection pattern including horizontal lines (M11, K11, Y11, C11, M51, K51, Y51, C51, and M21, K21, Y21, C21) and oblique lines (M31, K31, Y31, C31, M61, K61, Y61, C61, and M41, K41, Y41, C41) of the respective colors, still another image misregistration detection pattern including horizontal lines (M12, K12, Y12, C12, M52, K52, Y52, C52, and M22, K22, Y22, C22) and oblique lines (M32, K32, Y32, C32, M62, K62, Y62, C62, and M42, K42, Y42, C42) of the respective colors, . . . , and further another image misregistration detection pattern including horizontal lines (M1n, K1n, Y1n, C1n, M5n, K5n, Y5n, C5n, and M2n, K2n, Y2n, C2n) and oblique lines (M3n, K3n, Y3n, C3n, M6n, K6n, Y6n, C6n, and M4n, K4n, Y4n, C4n) of the respective colors. The amounts of deviations calculated for the respective sets are averaged, thereby reducing various errors. Here, the various errors include, for example, a detection error of the sensor, a speed fluctuation of the secondary transfer belt 24, and the like. The image misregistration detection patterns including the spot colors illustrated in FIG. 17 are also arranged in the same manner.

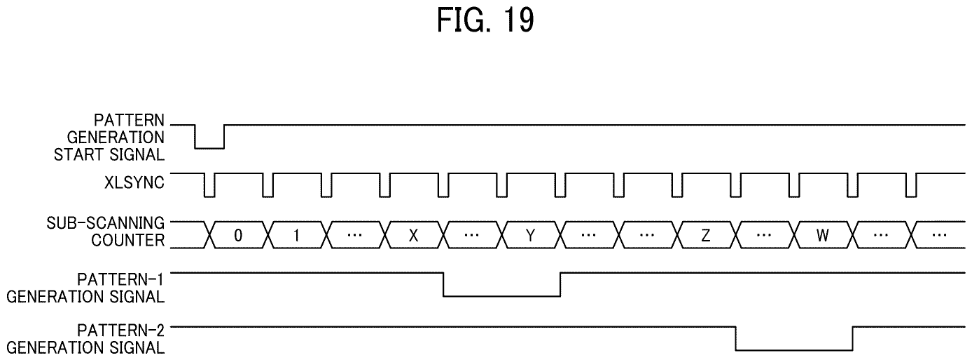

FIG. 19 illustrates an example of setting data of the interval from a horizontal line to an oblique pattern of an image misregistration detection pattern in the printer. In the present embodiment, the pattern formation controller 1303 operates in response to a pattern generation start signal. To be more specific, the sub-scanning counter 702a is reset, the sub-scanning counter 702a is counted up by the signal XLSYNC, and when the counter value of the sub-scanning counter 702a is between specific set values, an image misregistration detection pattern-1 (horizontal line pattern) and image misregistration detection pattern-2 (oblique line pattern) of the same color are generated. The timing chart shown in FIG. 19 schematically shows only the generation of the image misregistration detection pattern on the line (sub-scanning direction) of any of the sensor 1, the sensor 2, and the sensor 3 that detect the image misregistration detection pattern.

When the counter value of the sub-scanning counter 702a is between a specified setting value 1 (X in this case) and a setting value 2 (Y), the pattern formation controller 1303 generates the image misregistration detection pattern-1 in the sub-scanning direction, and when the counter value is between a setting value 3 (Z) and a setting value 4 (W), the pattern formation controller 1303 generates the image misregistration detection pattern-2 in the sub-scanning direction. At this time, the counter set value of the interval from the horizontal line to the oblique line can be expressed as (Z+W)/2−(X+Y)/2 using the intermediate counter value (X+Y)/2 of the horizontal line and the intermediate counter value (Z+W)/2 of the oblique line. By multiplying the counter set value by the period TL of the signal XLSYNC, the time of the interval between the horizontal line and the oblique line of the same color can be obtained. The ideal time T_i can be used as the time TK′mn between a pattern line Km and a pattern line Kn in the execution of the previous correction illustrated in FIG. 15.

As described above, according to the printer 100 of the present embodiment, the image misregistration correction of the reference color is executed at the same timing as the image misregistration correction performed on the colors other than the reference color, and therefore, the temporal change in the image position can be suppressed.

The program executed by the printer 100 according to the present embodiment is provided by being incorporated in the ROM 506c or the like in advance. The program executed by the printer 100 according to the present embodiment may be recorded in a computer-readable recording medium such as a compact disc-read-only memory (CD-ROM), a flexible disk (FD), a compact disc-recordable (CD-R), or a digital versatile disk (DVD) in a file of an installable format or an executable format and provided.

Furthermore, the program executed by the printer 100 of the present embodiment may be stored in a computer connected to a network such as the Internet and provided by being downloaded via the network. The program executed by the printer 100 according to the present embodiment may be provided or distributed via a network such as the Internet.

The program executed by the printer 100 of the present embodiment has a module configuration including the above-described respective devices (the correction data setting device 1301, the pattern formation controller 1303, the pattern detector 1305, the deviation amount calculator 1307, the determination device 1302, the correction data calculator 1304, the storage controller 1306, and the image formation controller 1308), and as actual hardware, an example of a processor such as the CPU 506a reads the program from the ROM 506c and executes the program, so that the above-described respective devices are loaded on a main memory, and the correction data setting device 1301, the pattern formation controller 1303, the pattern detector 1305, the deviation amount calculator 1307, the determination device 1302, the correction data calculator 1304, the storage controller 1306, and the image formation controller 1308 are generated on the main memory.

In the above-described embodiment, the image forming apparatus of the present disclosure is applied to a multifunction peripheral having at least two functions of a copy function, a printer function, a scanner function, and a facsimile function, but can be applied to any image forming apparatus such as a copier, printer, scanner, or facsimile machine.

The image forming apparatus may be, for example, an inkjet image forming apparatus. In such a case, the inkjet image forming apparatus includes inkjet heads as image formers, which correspond to the image forming devices (including the developing devices) of the printer in the above-described embodiment. Since the inkjet image forming apparatus does not include the optical writer in the above-described embodiment, the direction orthogonal to a moving direction of a conveyance belt of the inkjet image forming apparatus corresponds to the main scanning direction in the above-described embodiment.

Aspects of the present disclosure are, for example, as follows.

### First Aspect

An image forming apparatus includes: an optical writer that, according to image data, irradiates an image bearer with a light beam to form latent images; toner developing devices for a plurality of colors to develop the latent images; a generator to generate image data of an image misregistration detection pattern; a transfer device to transfer, onto a belt, toner images of the plurality of colors obtained by developing the latent images based on the image data of the image misregistration detection pattern; a detector to detect the toner images of the image misregistration detection pattern of the plurality of colors transferred onto the belt; and a corrector to correct, based on a detection result of the toner images of the image misregistration detection pattern, a deviation of an image position of a color, which is other than a reference color among the plurality of colors, with respect to an image position of the reference color. The image misregistration detection pattern includes two patterns. The two patterns include a pattern parallel to a main scanning direction which is an irradiation direction of the light beam and a pattern angled with respect to the main scanning direction. The corrector calculates, based on a detection result of an interval between the two patterns of the reference color by the detector, a reference color correction amount for correcting a deviation of the image position of the reference color in the main scanning direction, and corrects the deviation of the image position of the reference color in the main scanning direction based on the reference color correction amount.

### Second Aspect

In the image forming apparatus according to the first aspect, the corrector corrects the deviation of the image position of the color other than the reference color in the main scanning direction based on the reference color correction amount.

### Third Aspect

In the image forming apparatus according to the first or second aspect, the corrector calculates the reference color correction amount for correcting the deviation of the image position of the reference color using the reference color correction amount calculated in the preceding correction of the deviation of the image position.

### Fourth Aspect

In the image forming apparatus according to the first or second aspect, the corrector calculates the reference color correction amount for correcting the deviation of the image position of the reference color by using pattern setting data used for generating the image misregistration detection pattern.

### Fifth Aspect

The image forming apparatus according to any one of the first to fourth aspects further includes a plurality of sensors positioned along the main scanning direction. The detector detects the toner images of the image misregistration detection pattern using the plurality of sensors, and the corrector calculates the reference color correction amount for correcting the deviation of the image position of the reference color based on the detection result detected using a sensor on a scanning start side among the plurality of sensors.

### Sixth Aspect

The image forming apparatus according to any one of the first to fourth aspects further includes a plurality of sensors positioned along the main scanning direction. The detector detects the toner images of the image misregistration detection pattern using the plurality of sensors, and the corrector calculates the reference color correction amount for correcting the deviation of the image position of the reference color based on the detection result detected using the plurality of sensors.

### Seventh Aspect

An image forming method executed by an image forming apparatus that includes: an optical writer to form a latent image by irradiating an image bearer with a light beam according to image data; toner developing devices of a plurality of colors to develop the latent image; and a transfer device to transfer, onto a belt, toner images of a plurality of colors obtained by developing the latent image based on image data of an image registration detection pattern. The method includes detecting the toner images of the image misregistration detection pattern of the plurality of colors transferred onto the belt, and correcting, based on a detection result of the toner images of the image misregistration detection pattern, a deviation of an image position of a color other than a reference color serving as a reference among the plurality of colors with respect to the reference color. The image misregistration detection pattern includes two patterns including a pattern parallel to a main scanning direction which is an irradiation direction of the light beam and a pattern angled with respect to the main scanning direction. The correcting includes calculating a reference color correction amount for correcting a deviation of the image position of the reference color in the main scanning direction based on a detection result of an interval between the two patterns of the reference color by the detection, and correcting the deviation of the image position of the reference color in the main scanning direction based on the reference color correction amount.

### Eighth Aspect

A program causes a computer controlling an image forming apparatus, which includes: an optical writer to form a latent image by irradiating an image bearer with a light beam according to image data; toner developing devices of a plurality of colors to develop the latent image; and a transfer device to transfer, onto a belt, toner images of a plurality of colors obtained by developing the latent image based on image data of an image registration detection pattern, function as: a detector to detect the toner images of the image misregistration detection pattern of the plurality of colors transferred onto the belt; and a corrector to correct, based on a detection result of the toner images of the image misregistration detection pattern, a deviation of an image position of a color other than a reference color, serving as a reference among the plurality of colors, with respect to an image position of the reference color. The image misregistration detection pattern includes two patterns including a pattern parallel to a main scanning direction which is an irradiation direction of the light beam and a pattern angled with respect to the main scanning direction. The corrector calculates a reference color correction amount for correcting a deviation of the image position of the reference color in the main scanning direction based on a detection result of an interval between the two patterns of the reference color by the detector, and corrects the deviation of the image position of the reference color in the main scanning direction based on the reference color correction amount.

1. An image forming apparatus, comprising:
a plurality of image bearers;
an optical writer that, according to image data, irradiates the plurality of image bearers with light beams to form latent images;
a plurality of developing devices to develop the latent images with toner of a plurality of colors, wherein the plurality of colors includes a reference color and another color other than the reference color;
a transfer device to transfer, onto a belt, toner images of the plurality of colors obtained by developing the latent images based on image data of an image misregistration detection pattern, wherein the image misregistration detection pattern includes a first pattern parallel to a main scanning direction in which the light beams from the optical writer move on the plurality of image bearers and a second pattern angled with respect to the main scanning direction; and
processing circuitry configured to:
generate the image data of the image misregistration detection pattern;
detect the toner images of the image misregistration detection pattern of the plurality of colors transferred onto the belt;
correct, based on a detection result of the toner images of the image misregistration detection pattern, a deviation of an image position of the another color with respect to an image position of the reference color;
calculate, based on a detection result of an interval between the first pattern and the second pattern, a reference color correction amount for correcting a deviation of the image position of the reference color in the main scanning direction; and
correct, based on the reference color correction amount, the deviation of the image position of the reference color in the main scanning direction.

2. The image forming apparatus according to claim 1, wherein the processing circuitry is further configured to correct the deviation of the image position of the another color in the main scanning direction based on the reference color correction amount.

3. The image forming apparatus according to claim 1, wherein the processing circuitry is further configured to calculate the reference color correction amount for correcting the deviation of the image position of the reference color by using a value of the reference color correction amount calculated in a preceding correction of the deviation of the image position.

4. The image forming apparatus according to claim 1, wherein the processing circuitry is further configured to calculate the reference color correction amount for correcting the deviation of the image position of the reference color, using pattern setting data used for generating the image misregistration detection pattern.

5. The image forming apparatus according to claim 1, further comprising:
a plurality of sensors positioned along the main scanning direction, wherein
the processing circuitry is further configured to detect the toner images of the image misregistration detection pattern using output of the plurality of sensors, and the processing circuitry is further configured to calculate the reference color correction amount for correcting the deviation of the image position of the reference color, based on a detection result detected according to the output of a sensor on a scanning start side among the plurality of sensors.

6. The image forming apparatus according to claim 1, further comprising:
a plurality of sensors positioned along the main scanning direction, wherein
the processing circuitry is further configured to detect the toner images of the image misregistration detection pattern using output of the plurality of sensors, and
the processing circuitry is further configured to calculate the reference color correction amount for correcting the deviation of the image position of the reference color, based on a detection result detected according to the output of the plurality of sensors.

7. The image forming apparatus according to claim 1, wherein
the second pattern is inclined at a preset angle with respect to the first pattern, and
the processing circuitry is configured to calculate the deviation of the image position of the reference color based on the preset angle.

8. The image forming apparatus according to claim 1, wherein the second pattern is inclined at 45 degrees with respect to the first pattern.

9. The image forming apparatus according to claim 1, wherein the reference color is black.

10. The image forming apparatus according to claim 1, wherein the processing circuitry is further configured to
determine whether to perform a correction of the deviation of the image position based on the detection result of the toner images of the image misregistration detection pattern, and
perform the correction when an amount of the deviation is equal to or greater than a threshold.

11. The image forming apparatus according to claim 1, wherein the processing circuitry is further configured to execute the correction of the deviation of the image position when at least one of the following conditions is satisfied:
a print mode of the image forming apparatus is switched,
a number of sheets printed since a preceding correction reaches a specified number, or
a temperature change equal to or greater than a specified value is detected.

12. The image forming apparatus according to claim 1, wherein
a plurality of sets of the image misregistration detection pattern are arranged in a moving direction of the belt, and
the processing circuitry is further configured to calculate amounts of deviations for each set of the image misregistration detection pattern and average the calculated amounts of deviations.

13. The image forming apparatus according to claim 1, further comprising a plurality of sensors configured to detect the toner images of the image misregistration detection pattern transferred onto the belt.

14. The image forming apparatus according to claim 1, wherein the processing circuitry is further configured to correct an image magnification in the main scanning direction by varying a frequency of a pixel clock based on the detection result of the toner images of the image misregistration detection pattern.

15. The image forming apparatus according to claim 1, wherein the reference color correction amount is a set value of a main scanning control signal that determines the image position of the reference color in the main scanning direction.

16. The image forming apparatus according to claim 1, wherein the processing circuitry is further configured to correct a deviation of an image position of the another color in a sub-scanning direction perpendicular to the main scanning direction, based on the detection result of the toner images of the image misregistration detection pattern.

17. The image forming apparatus according to claim 1, wherein
the processing circuitry is further configured to calculate the reference color correction amount based on a difference between a first measurement time and a second measurement time,
the first measurement time is from the first pattern to the second pattern of the reference color detected in a current correction, and
the second measurement time is from the first pattern to the second pattern of the reference color detected in a preceding correction.

18. The image forming apparatus according to claim 1, wherein
the plurality of colors further includes a spot color,
the image misregistration detection pattern further includes patterns of the spot color, and
the processing circuitry is further configured to correct a deviation of an image position of the spot color based on the detection result of the toner images of the image misregistration detection pattern.

19. An image forming method executed by an image forming apparatus, the image forming method comprising:
detecting toner images of an image misregistration detection pattern of a plurality of colors transferred onto a belt of the image forming apparatus, the plurality of colors including a reference color and another color other than the reference color; and
correcting, based on a detection result of the toner images of the image misregistration detection pattern, a deviation of an image position of the another color with respect to an image position of the reference color, wherein
the image misregistration detection pattern includes a first pattern parallel to a main scanning direction in which light beams from an optical writer of the image forming apparatus move on a plurality of image bearers of the image forming apparatus and a second pattern angled with respect to the main scanning direction, and
the correcting includes:
calculating, based on a detection result of an interval between the first pattern and the second pattern, a reference color correction amount for correcting a deviation of the image position of the reference color in the main scanning direction; and
correcting, based on the reference color correction amount, the deviation of the image position of the reference color in the main scanning direction.

20. An image forming apparatus, comprising:
a plurality of image formers to form images of a plurality of colors, wherein the plurality of colors includes a reference color and another color other than the reference color;
a transfer device to transfer, onto a belt, the images of the plurality of colors formed by the plurality of image formers based on image data of an image misregistration detection pattern, wherein the image misregistration detection pattern includes a first pattern orthogonal to a moving direction of the belt and a second pattern angled with respect to the moving direction of the belt; and
processing circuitry configured to:
generate the image data of the image misregistration detection pattern;
detect the images of the image misregistration detection pattern of the plurality of colors transferred onto the belt;
correct, based on a detection result of the images of the image misregistration detection pattern, a deviation of an image position of the another color with respect to an image position of the reference color;
calculate, based on a detection result of an interval between the first pattern and the second pattern, a reference color correction amount for correcting a deviation of the image position of the reference color in the moving direction of the belt; and
correct, based on the reference color correction amount, the deviation of the image position of the reference color in the moving direction of the belt.
